(19) United States
(12) Patent Application Publication
(10) Pub. No.: US 2013/0255785 A1
(43) Pub. Date: Oct. 3, 2013

(54) PIPES AND CONNECTORS MADE OF POLYBIPHENYL ETHER SULFONE POLYMERS FOR CONVEYING GASES

(71) Applicant: BASF SE, Ludwigshafen (DE)

(72) Inventors: Jochen Schmid, Dossenheim (DE); Frank Ehret, Maxdorf (DE); Christian Maletzko, Altrip (DE)

(73) Assignee: BASF SE, Ludwigshafen (DE)

(21) Appl. No.: 13/851,611

(22) Filed: Mar. 27, 2013

Related U.S. Application Data
(60) Provisional application No. 61/616,443, filed on Mar. 28, 2012.

(51) Int. Cl. C08G 75/23; C08L 81/06

(52) U.S. Cl. CPC C08G 75/23; C08L 81/06
USPC 137/1; 528/174; 525/534; 525/419; 525/471

(57) ABSTRACT

The invention relates to the use of a thermoplastic molding composition which comprises at least one polybiphenyl ether sulfone polymer, to produce moldings for conveying gas.

This patent application claims the benefit of pending U.S. provisional patent application Ser. No. 61/616,443 filed on Mar. 28, 2012, incorporated in its entirety herein by reference.

The present invention relates to the use of a thermoplastic molding compositing comprising at least one polybiphenyl ether sulfone polymer, to produce self-supporting moldings for conveying gases.

Piping systems are usually composed of self-supporting moldings, such as pipe sections, connectors, and pipe fittings.

Piping systems serve to transport flowable or pumpable solids, liquids, and gases. The requirements placed upon a piping system depend on the fluid to be transported. When gases are transported, the leakproof properties of the piping system are subject to particularly stringent requirements.

Materials used for piping systems are usually metallic materials such as brass, gunmetal, copper, steel, and malleable iron.

In order to protect piping systems against corrosion, said piping systems are lined from the inside with a plastics. Such linings are also denominated as “liner”. In said piping systems the liners are only used as a protection against corrosion. The liners in said piping systems are not used to fulfill a supporting function (load-bearing function). Said liners, therefore, are not self-supporting. The liners, moreover, are not used to increase the leakproofness of the piping systems. In piping systems which comprise liners, therefore, the metallic material (the jacket) fulfills the supporting function. The metallic material in said piping systems, moreover, is used to ensure the leakproofness of the piping system. Piping systems which are made from metallic material and which comprise a liner are resistant to corrosion and are suitable for conveying gases. Said piping systems, however, are expensive.

In order to provide low price piping systems, self-supporting piping systems made from plastics were developed. In this self-supporting piping systems the leakproofness and the supporting function is achieved only by the plastics. Such self-supporting piping systems, therefore, do not comprise jackets made from a metallic material.

Over a period of some years, self-supporting piping systems made of plastics have become increasingly important for the transport of gases. Plastics currently used here are polyethylene (PE), crosslinked polyethylene (PEX), and polyamides (PA).

Self-supporting moldings such as pipe sections and connectors for piping systems made of plastic are usually manufactured by shaping processes starting from molding compositions. In the shaping processes, the molding composition is molded by exposure to mechanical forces within a particular temperature range. Examples of suitable shaping processes are injection molding, extrusion, and compression molding.

When piping systems made of plastics are compared with piping systems made of metallic materials, the former have the advantage that, because of the mechanical properties of their materials, they are capable of substantially easier installation. The properties of the abovementioned plastics are satisfactory in relation to the properties required for installation of piping systems.

However, there is still room for improvement in relation to leak prevention, in particular during transport of gases. This is particularly applicable to the connection points where a connector connects two pipe sections to one another.

When piping systems made of the abovementioned plastics are used, in particular when they are used in unventilated or poorly ventilated regions, problems frequently occur. When odorous gases, such as natural gas and other fuel gases, are transported, escape of odorous material can trigger false alarms. In the worst case, explosive gas mixtures can form during the transport of combustible gases.

The object underlying the present invention therefore consists in providing self-supporting moldings for piping systems for conveying gases which are more leakproof than the known piping systems. The mechanical properties of the materials of the self-supporting moldings are moreover intended to be comparable with or better than those of self-supporting moldings described in the prior art.

The object is achieved through the use, in the invention, of a thermoplastic molding composition which comprises at least one polybiphenyl ether sulfone polymer, to produce self-supporting moldings for conveying gases.

Surprisingly, it has been found that the use of the thermoplastic molding composition in the invention can give self-supporting moldings which are suitable for the construction of piping systems for conveying gases. When the moldings and the piping systems constructed therefrom are compared with the systems described in the prior art, the former are more leakproof. The mechanical properties of the materials of the self-supporting moldings are moreover very good. In particular, they feature good impact resistance and good chemicals resistance. When the self-supporting moldings are used for the construction of piping systems for gases, triggering of false alarms and formation of explosive gas mixtures can moreover reliably be avoided.

The molding compositions used in the invention comprise at least one polybiphenyl ether sulfone polymer.

Preferred molding compositions comprise at least one polybiphenyl ether sulfone polymer which is produced through polycondensation comprising in step (a) the reaction of a component (a1) which comprises at least one aromatic dihydroxy compound with a component (a2) which comprises at least one aromatic sulfone compound having two halogen substituents, where component (a1) comprises 4,4′-dihydroxybiphenyl.

For the purposes of the present invention, polybiphenyl ether sulfone polymer means polyarylene ether sulfones which comprise 4,4′-dihydroxybiphenyl as monomer unit. Polybiphenyl ether sulfone itself is also known as polyphenyl sulfone, abbreviated to PPSU, and is composed of the following monomer units: 4,4′-dichlorodiphenyl sulfone and 4,4′-dihydroxybiphenyl.

Production processes which provide access to the abovementioned polybiphenyl ether sulfone polymers are known per se to the person skilled in the art. Production processes are described by way of example in WO 2010/142585, WO 2011/020823, and WO 2010/112508.

Preferred polybiphenyl ether sulfone polymers are described below.

For the purposes of the present invention, the structure of the polybiphenyl ether sulfone polymers is characterized by reference to the monomer units used. It is clear to the person skilled in the art that the monomer units are present in reacted form in the polymer, and that the reaction of the monomer units takes place through nucleophilic aromatic polycondensation with theoretical elimination of one unit of hydrogen halide as leaving group. The structure of the resultant polybiphenyl ether sulfone polymer does not therefore depend on the precise nature of the leaving group.

Preference is given to polybiphenyl ether sulfone polymers which are accessible through reaction of components a1) and a2) in the presence of an organic solvent. It is preferable that the organic solvent comprises N-methylpyrrolidone. Very particular preference is given to N-methylpyrrolidone as sole solvent. N-Methylpyrrolidone simultaneously contributes to high conversion of components (a1) and (a2), since the reaction of the monomers used in the invention proceeds particularly efficiently.

The person skilled in the art is per se aware of the temperature, the solvent, and the time required for the reaction of components (a1) and (a2) to give a polybiphenyl ether sulfone polymer. The starting compounds (a1) and (a2) are reacted at a temperature of from 80 to 250° C., preferably from 100 to 220° C., where the upper temperature limit for a synthesis at ambient pressure is subject to restriction by the boiling point of the solvent. The reaction preferably takes place within a period of from 2 to 12 h, in particular from 3 to 8 h.

The molar ratio (a1):(a2) of the components used can be in the range from 1.00:1.10 to 1.10:1.00, preferably in the range from 1.00:1.05 to 1.05:1.00, more preferably in the range from 1.00:1.02 to 1.02:1.00.

However, particular preference is given to polybiphenyl ether sulfone polymers produced by using an excess of component (a1). This helps to reduce the content of polymer-bonded chlorine, in particular at high conversions. The molar ratio (a1):(a2) of the components used is preferably from 1.005 to 1.1, more preferably from 1.005 to 1.05. In one particularly preferred embodiment, the molar ratio (a1):(a2) of the components is from 1.005 to 1.035, in particular from 1.01 to 1.03, very particularly preferably from 1.015 to 1.025. This can provide particularly effective control of molecular weight.

Preference is given to polybiphenyl ether sulfone polymers produced by selecting the reaction conditions in such a way that conversion (C) is at least 90%, in particular at least 95%, particularly preferably at least 98%. For the purposes of the present invention, conversion C is the molar proportion of reactive groups (i.e. hydroxy groups and halogen groups) reacted. The resultant polybiphenyl ether sulfone polymer has relatively broad molecular weight distribution, optionally inclusive of oligomers, where the terminal groups are either halogen groups, preferably chlorine groups, or hydroxy groups, or in the case of further reaction alkyl groups or aryloxy groups, and correspond to the theoretical difference from 100% conversion.

Preference is given to polybiphenyl ether sulfone polymers produced by using component (a1) composed of at least one aromatic dihydroxy compound which comprises 4,4′-dihydroxybiphenyl. Component (a1) can in particular moreover comprise the following compounds:
dihydroxybenzenes, in particular hydroquinone and/or resorcinol;
dihydroxynaphthalenes, in particular 1,5-dihydroxynaphthalene, 1,6-dihydroxynaphthalene, 1,7-dihydroxynaphthalene, and/or 2,7-dihydroxynaphthalene;
dihydroxybiphenyl compounds other than 4,4′-dihydroxybiphenyl, in particular 2,2′-dihydroxybiphenyl;
bisphenyl ether, in particular bis(4-hydroxyphenyl)ether and bis(2-hydroxyphenyl)ether;
bisphenylpropanes, in particular 2,2-bis(4-hydroxyphenyl)propane, 2,2-bis(3-methyl-4-hydroxyphenyl)propane, and/or 2,2-bis(3,5-dimethyl-4-hydroxyphenyl)propane;
bisphenylmethanes, in particular bis(4-hydroxyphenyl)methane;
bisphenylcyclohexanes, in particular bis(4-hydroxyphenyl)-2,2,4-trimethylcyclohexane;
bisphenyl sulfones, in particular bis(4-hydroxyphenyl)sulfone;
bisphenyl sulfides, in particular bis(4-hydroxyphenyl)sulfide;
bisphenyl ketones, in particular bis(4-hydroxyphenyl)ketone;
bisphenylhexafluoropropanes, in particular 2,2-bis(3,5-dimethyl-4-hydroxyphenyl)hexafluoropropane; and/or
bisphenylfluorenes, in particular 9,9-bis(4-hydroxyphenyl)fluorene.

Component (a1) preferably comprises at least 50% by weight, in particular at least 60% by weight, particularly preferably at least 80% by weight, of 4,4′-dihydroxybiphenyl, based in each case on the total weight of component (a1). It is very particularly preferable that component (a1) consists of 4,4′-dihydroxybiphenyl.

Further preference is given to polybiphenyl ether sulfone polymers produced by using, as component (a2), at least one aromatic sulfone compound having two halogen substituents and selected from the group consisting of dihalodiphenyl sulfones, such as 4,4′-dichlorodiphenyl sulfone, 4,4′-difluorodiphenyl sulfone, 4,4′-dibromodiphenyl sulfone, bis(2-chlorophenyl)sulfones, 2,2′-dichlorodiphenyl sulfone and 2,2′-difluorodiphenyl sulfone.

Component (a2) is preferably selected from 4,4′-dihalodiphenyl sulfones, in particular 4,4′-dichlorodiphenyl sulfone and/or 4,4′-difluorodiphenyl sulfone.

In one very particularly preferred embodiment, component (a2) is 4,4′-dichlorodiphenyl sulfone.

Preferred polybiphenyl ether sulfone polymers have units of the formula (I)

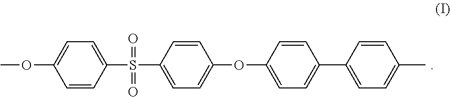

The polybiphenyl ether sulfone polymer can moreover comprise other units selected from the units of the formulae (II) and (Ill)

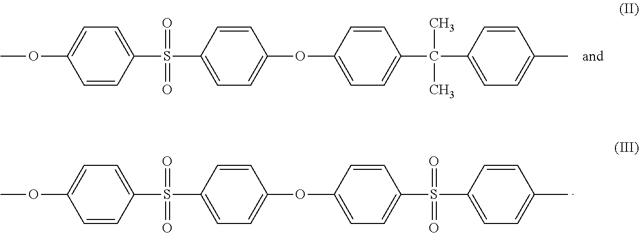

It is preferable that the polybiphenyl ether sulfone polymer comprises at least 50% of the unit of the formula (I), preferably at least 60%, more preferably at least 70%, and in particular at least 80%, based in each case on the total number of the units of the formulae (I), (II), and (III) comprised in the polybiphenyl ether sulfone polymer.

Particular preference is given to a polybiphenyl ether sulfone polymer which can be produced through polycondensation of 4,4′-dihydroxybiphenyl (a1) with 4,4′-dichlorodiphenyl sulfone (a2).

Components (a1) and (a2) are preferably reacted in the presence of a base (B) in order to increase reactivity with respect to the halogen substituents of the starting compounds (a2). It is preferable, starting from the abovementioned aromatic dihydroxy compounds (a1), to produce the dipotassium or disodium salts of these through addition of a base (B), and to react these with component (a2). Suitable bases (B) are known to the person skilled in the art. Preferred bases are in particular alkali metal carbonates.

The bases are preferably anhydrous. Particularly suitable bases are anhydrous alkali metal carbonates, preferably sodium carbonate, potassium carbonate, calcium carbonate, or a mixture thereof, and very particular preference is given here to potassium carbonate. A particularly preferred combination is N-methyl-2-pyrrolidone as solvent and anhydrous potassium carbonate as base.

It has moreover proven advantageous for the purposes of step (a) to set the amount of the polybiphenyl ether sulfone polymer, based on the total weight of the mixture of polybiphenyl ether sulfone polymer and solvent, at from 10 to 70% by weight, preferably from 15 to 50% by weight.

In another embodiment, during or after the reaction, at least one aromatic organic monochloro compound is added as component (a3). It is believed that the aromatic organic monochloro compound functions as chain regulator. It is preferable that the reactivity, for the purposes of the reaction, of the aromatic organic monochloro compound is similar to that of component (a2).

It is preferable that component (a3) is an aromatic monochloro sulfone, in particular monochlorodiphenyl sulfone. In one preferred embodiment, the excess of component (a1) is compensated by the aromatic organic monochloro compound (a3) which comprises a chlorine group that is reactive under the conditions of the reaction of components (a1) and (a2).

The molar amount of component (a3) is preferably selected in such a way that the excess of the molar amount of component (a1) over the molar amount of component (a2) multiplied by two and divided by the molar amount of component (a3) is from 0.98 to 1.02, in particular from 0.99 to 1.01. Accordingly, 2*((a1)−(a2))/(a3) is preferably from 0.98 to 1.02, in particular from 0.99 to 1.01, where (a1), (a2) and (a3) represent the molar amounts used of the respective component.

It is preferable that the ratio ((a1)−(a2)/(a3)) here multiplied by two gives 1.

In another preferred embodiment, which can advantageously be linked with the abovementioned embodiments, step (a) is followed by step (b) in which reaction with at least one aliphatic organic halogen compound takes place. Reactive terminal hydroxy groups are thus subjected to a further reaction, and degradation of the polymer chain is thus inhibited.

Preferred aliphatic organic halogen compounds are alkyl halides, in particular alkyl chlorides having linear or branched alkyl groups having from 1 to 10 carbon atoms, in particular primary alkyl chlorides, particularly preferably methyl halide, in particular methyl chloride.

The reaction in step (b) is preferably carried out at a temperature of from 90° C. to 160° C., in particular from 100° C. to 150° C. The reaction time can vary widely and is usually at least 5 minutes, in particular at least 15 minutes. It is preferable that the reaction time in step (b) is from 15 minutes to 8 hours, in particular from 30 minutes to 4 hours.

Various methods can be used to add the aliphatic organic halogen compound. The aliphatic organic halogen compound can moreover be added stoichiometrically or in excess, and the excess here can by way of example be up to 5-fold. In one preferred embodiment, the aliphatic organic halogen compound is added continuously, in particular through continuous introduction in the form of gas stream.

It has proven advantageous, following step (a) and optionally step (b), to filter the polymer solution. This removes the salt formed during polycondensation, and also removes any gel that may have formed.

The polymer solution can be subjected to further work-up in order to obtain the polybiphenyl ether sulfone polymer in pure form, for example through removal of the solvent by known methods, such as spray drying, or by precipitation of the polymer, for example through dropwise introduction of the polymer solution into water.

The weight-average molar masses M_{w} of the polybiphenyl ether sulfone polymer comprised in the molding composition used in the invention are generally in the range from 20 000 to 90 000 g/mol, preferably in the range from 30 000 to 70 000 g/mol and particularly preferably in the range from 40 000 to 50 000 g/mol. The molar mass can be determined by means of gel permeation chromatography, and it is preferable here to use DMAc with 0.5% of LiBr as solvent or mobile phase, and to carry out measurements at 80° C. by comparison with polymethyl acrylate (PMMA) of defined molar masses.

Another feature of the polybiphenyl ether sulfone polymer is a nominal tensile strain at break of more than 40% at a separation velocity (v) of 50 mm/min in the ISO 527-2 tensile test.

The notched impact resistance of the polybiphenyl ether sulfone polymer at 23° C. in accordance with ISO 179-1eA is at least 35 kJ/m², preferably at least 45 kJ/m², and particularly preferably at least 60 kJ/m².

Another feature of the polybiphenyl ether sulfone polymer is very good chemicals resistance.

Surprisingly, it has been found that the gas permeability of the polybiphenyl ether sulfone polymer is markedly less than that of the plastics described in the prior art (gas permeability measured in accordance with DIN 53380 on equipment from Brugger), and, moreover show superior mechanical properties.

The thermoplastic molding compositions used in the invention can comprise further polymers alongside the polybiphenyl ether sulfone polymer. Suitable further polymers are those selected from the group consisting of polyether sulfone (PESU), polysulfone (PSU), polyetherimides, polyphenylene sulfides, polyether ether ketones, polyimides, and poly-p-phenylenes.

Particularly preferred further polymers are polysulfone (PSU) and/or polyether sulfone (PESU).

The content of further polymers in the molding composition used in the invention is generally at most 30% by weight, preferably at most 20% by weight, particularly preferably at most 10% by weight, based in each case on the total weight of the polymers comprised in the molding composition.

The molding compositions used in the invention can moreover comprise fillers, in particular fibers, particularly preferably glass fibers. Appropriate fillers are known to the person skilled in the art. Insofar as fillers are used, the amount added thereof is preferably from 5 to 150 parts by weight, based on 100 parts by weight of polymer.

Materials which can in particular be present in the thermoplastic molding compositions of the invention are any of the glass fibers that are known to the person skilled in the art and are suitable for use in thermoplastic molding compositions. Said glass fibers can be produced by processes known to the person skilled in the art and can optionally be surface-treated. The glass fibers can have been treated with a size in order to improve compatibility with the matrix material, for example as described in DE 10117715.

In one preferred embodiment, glass fibers with a diameter of from 5 to 15 μm are used, preferably from 7 to 13 μm, particularly preferably from 9 to 11 μm.

The form in which the glass fibers are incorporated can be that of chopped glass fibers or else that of continuous strands (rovings). The length of the glass fibers that can be used is generally and typically from 4 to 5 mm prior to incorporation in the form of chopped glass fibers into the thermoplastic molding compositions. After the processing of the glass fibers with the other components, for example through coextrusion, the average length of the glass fibers is usually from 100 to 400 μm, preferably from 150 to 250 μm.

The molding compositions of the invention can comprise, as further component K, auxiliaries, in particular processing aids, pigments, stabilizers, flame retardants, or a mixture of various additives. Examples of other usual additives are oxidation retarders, agents to counteract decomposition by heat and decomposition by ultraviolet light, lubricants and mold-release agents, dyes, and plasticizers.

The proportion of the further components K in the molding compositions of the invention is in particular from 0 to 30% by weight, preferably from 0 to 20% by weight, in particular from 0 to 15% by weight, based on the total weight of the thermoplastic molding composition. If component K involves stabilizers, the proportion of said stabilizers is usually up to 2% by weight, preferably from 0.01 to 1% by weight, in particular from 0.01 to 0.5% by weight, based on the total weight of the thermoplastic molding composition.

The amounts comprised of pigments and dyes are generally from 0 to 10% by weight, preferably from 0.05 to 7% by weight, and in particular from 0.1 to 5% by weight, based on the total weight of the thermoplastic molding composition.

Pigments for the coloring of thermoplastics are well known, see for example R. Gächter and H. Müller, Taschenbuch der Kunststoffadditive [Plastics additives handbook], Carl Hanser Verlag, 1983, pages 494 to 510. A first preferred group of pigments that may be mentioned are white pigments, such as zinc oxide, zinc sulfide, white lead [2 PbCO₃.Pb(OH)₂], lithopones, antimony white, and titanium dioxide. Of the two most familiar crystalline forms of titanium dioxide (rutile and anatase), it is in particular the rutile form which is used for white coloring of the molding compositions of the invention. Black color pigments which can be used according to the invention are iron oxide black (Fe₃O₄), spinel black [Cu(Cr, Fe)₂O₄], manganese black (a mixture composed of manganese dioxide, silicon dioxide, and iron oxide), cobalt black, and antimony black, and also particularly preferably carbon black, which is mostly used in the form of furnace black or gas black. In this connection see G. Benzing, Pigmente für Anstrichmittel [Pigments for paints], Expert-Verlag (1988), pages 78 ff.

Particular color shades can be achieved by using inorganic chromatic pigments, such as chromium oxide green, or organic chromatic pigments, such as azo pigments or phthalocyanines. Pigments of this type are generally commercially available.

Examples of oxidation retarders and heat stabilizers which can be added to the thermoplastic compositions according to the invention are halides of metals of group I of the Periodic Table of the Elements, e.g. sodium halides, potassium halides, or lithium halides, examples being chlorides, bromides, or iodides. Zinc fluoride and zinc chloride can moreover be used. It is also possible to use sterically hindered phenols, hydroquinones, substituted representatives of said group, secondary aromatic amines, if appropriate in combination with phosphorus-containing acids, or to use their salts, or a mixture of said compounds, preferably in concentrations up to 1% by weight, based on the total weight of the thermoplastic molding composition.

Examples of UV stabilizers are various substituted resorcinols, salicylates, benzotriazoles, and benzophenones, the amounts generally used of these being up to 2% by weight.

Lubricants and mold-release agents, the amounts of which added are generally up to 1% by weight, based on the total weight of the thermoplastic molding composition, are stearyl alcohol, alkyl stearates and stearamides, and also esters of pentaerythritol with long-chain fatty acids. It is also possible to use dialkyl ketones, such as distearyl ketone.

The molding compositions of the invention comprise, as preferred constituent, from 0.1 to 2% by weight, preferably from 0.1 to 1.75% by weight, particularly preferably from 0.1 to 1.5% by weight, and in particular from 0.1 to 0.9% by weight (based on the total weight of the thermoplastic molding composition) of stearic acid and/or stearates. Other stearic acid derivatives can in principle also be used, examples being esters of stearic acid.

Stearic acid is preferably produced via hydrolysis of fats. The products thus obtained are usually mixtures composed of stearic acid and palmitic acid. These products therefore have a wide softening range, for example from 50 to 70° C., as a function of the constitution of the product. Preference is given to use of products with more than 40% by weight content of stearic acid, particularly preferably more than 60% by weight. It is also possible to use pure stearic acid (>98%).

The molding compositions of the invention can moreover also comprise stearates. Stearates can be produced either via reaction of corresponding sodium salts with metal salt solutions (e.g. CaCl₂, MgCl₂, aluminum salts) or via direct reaction of the fatty acid with metal hydroxide (see for example Baerlocher Additives, 2005). It is preferable to use aluminum tristearate.

The constituents of the thermoplastic molding composition of the invention can be mixed in any desired sequence.

The molding compositions used in the invention can be produced by processes known per se, for example by extrusion. The molding compositions can by way of example be produced by mixing the starting components in conventional mixing apparatuses, such as screw-based extruders, preferably twin-screw extruders, Brabender mixers or Banbury mixers, or else kneaders, and then extruding same. The extrudate is cooled and comminuted. The sequence of mixing of the components can be varied, and it is therefore possible to premix two or optionally three components, or else to mix all of the components together.

Intensive mixing is advantageous in order to obtain maximum homogeneity of mixing. Average mixing times necessary for this are generally from 0.2 to 30 minutes at temperatures of from 280 to 380° C., preferably from 290 to 370° C. The extrudate is generally cooled and comminuted.

The molding compositions used in the invention and the inventive self-supporting moldings feature good flowability, high toughness, especially tensile strain at break and notched impact strength, and high surface quality. The values for the tensile strain at break, notched impact resistance, and chemicals resistance of the molding compositions and of the moldings produced therefrom are in the region of the values stated above for the polybiphenyl ether sulfone polymer, and the information and preferences stated in that connection therefore apply correspondingly.

The self-supporting moldings used in the invention are produced by processes known per se, for example extrusion processes, injection-molding processes, injection-blow-molding processes, or injection-stretch-blow-molding processes.

Surprisingly, it has been found that the self-supporting moldings manufactured from the molding composition described above are suitable for the construction of piping systems for conveying gases. A feature of the resultant self-supporting moldings is that they are very leakproof. The gas permeability of the self-supporting moldings is markedly less than that of the self-supporting moldings described in the prior art for conveying gases (gas permeability measured in accordance with DIN 53380 on equipment from Brugger). The self-supporting moldings and the piping systems constructed therefrom are particularly suitable for conveying methane- and ethane-containing gases, such as natural gas.

The term “self-supporting” means that the self-supporting moldings consist essentially of the thermoplastic a molding composition used for production.

The term “consisting essentially of” means that the self-supporting molding contains at least 80% by weight, preferably at least 90% by weight, more preferably at least 95% by weight and most preferably at least 99% by weight of the thermoplastic molding composition used for production. The weight-% are based on the total weight of the thermoplastic molding composition used for the production of the self-supporting molding. In a further preferred embodiment of the invention the self-supporting molding consists of the thermoplastic molding composition which was used for the production of the self-supporting molding.

The tern “self-supporting” means, moreover, that the self-supporting molding does not contain other reinforcement agents to increase the mechanical stability or the leakproofness beside the thermoplastic molding composition. In a specially preferred embodiment the self-supporting molding does not contain a jacket. Most preferred the self-supporting molding does not contain a jacket made from a metallic material.

The self-supporting molding produced by the use of a thermoplastic molding composition according to the invention, most preferably is not a liner, for example as used for the protection against corrosion in piping systems made from metallic material.

The present invention, moreover, provides the use of a thermoplastic molding composition which comprises at least one biphenyl ether sulfone polymer to produce self-supporting moldings for conveying a gas, where the self-supporting molding essentially consists of the thermoplastic molding composition which was used for the production.

Moreover, the present invention provides the use of a thermoplastic molding composition which comprises at least one polybiphenyl ether sulfone polymer to produce self-supporting moldings for conveying a gas, where the self-supporting molding does not contain a jacket, especially does not contain a jacket made from a metallic material.

The present invention therefore also provides the use of moldings produced from the molding composition described above, for conveying gases, where the information and preferences given above in respect of the molding composition and of the polymer(s) comprised in the molding composition apply correspondingly.

The present invention also provides the use of self-supporting moldings made of the molding compositions described above for conveying gases, where the information and preferences given above in respect of the molding composition and of the polymer(s) comprised in the molding composition apply correspondingly.

The present invention also provides the use of the self-supporting moldings described above for the construction of piping systems for gases.

A piping system for conveying gases comprises the following components: pipe sections, connectors, closures, and pipe fittings, such as valves, thermometers, and manometers.

For the purposes of the present invention, self-supporting moldings for conveying gases are plastics products produced from the molding compositions described above.

The self-supporting moldings are preferably those selected from the group consisting of pipe sections, connectors, and closures. Particularly preferred moldings are connectors and closures, in particular connectors.

For the purposes of the present invention, pipe sections are by way of example straight pipe sections and curved pipe sections. Straight pipe sections are preferred. The pipe sections can be produced by way of example by extrusion processes, injection-molding processes, injection-blow-molding processes, or injection-stretch-blow-molding processes. The length and the diameter of the pipe sections can vary widely and depend on the intended application sector.

Connectors and closures are also termed fittings.

Fittings preferred as self-supporting moldings are tested by way of example in accordance with DVGW W534 for their suitability for providing leakproof functioning and mechanical and thermal stability for 50 years. Design and dimensioning is based on the curves and material-specific dimensioning system of DIN ISO 9080. The fittings can be produced by way of example by extrusion processes, injection-molding processes, injection-blow-molding processes, or injection-stretch-blow-molding processes. The shape of the fittings can vary widely.

Mention may be made by way of example of fittings for connecting two or more pipe sections to one another, fittings for connecting pipe sections to gas-conveying fittings, such as valves, seals, flow meters, thermometers, or manometers, and closures for closing apertures in the gas-piping system, for example pipe ends. There is great freedom in respect of the design of the moldings, since they can be produced by injection molding of plastics. Another advantage of said production process is that functional elements such as screw threads, snap clasps, or latching lugs can be integrated directly, without any need for subsequent operations on the molding.

Inventive examples are used below to illustrate the invention, which is not restricted thereto.

### EXAMPLE 1

Measurement of the permeation behavior of a foil produced from a molding composition which is composed of 100% of a polybiphenyl ether sulfone polymer derived from the unit of the formula (I). Weight-average molar mass (Mw) was determined as 41 000 g/mol. The molding composition used is marketed with trademark Ultrason P 3010 by BASF SE.

Test foils of thickness 50 μm (Ultrason P 3010 50 μm foil) and 100 μm (Ultrason P 3010 100 μm foil) were produced from the molding composition. Permeation behavior was measured in relation to methane and in relation to ethane. All of the measurements were made on Brugger equipment in accordance with DIN 53380 Part 1. This corresponds to ASTM D1434 82 and ISO 15 105 Part 1.

Two determinations were made for each gas on the two specimens. The thickness data are an average value from 10 measurement points within the respective test area.

Tables 1 and 2 below give the results.

Moreover, test foils from Ultrason P3010, HDPE (high density polyethylene) and PE100 (polyethylene) were produced. The test foil had a thickness of approximately 50 μm. The test foils were measured as described above. The permeation behavior in relation to methane is shown in table 3. The results prove that the inventive use leads to self-supporting moldings that show better leakproofness compared to self-supporting moldings as known in the state of the art.

TABLE 1
Methane - Dry permeability (measured
in accordance with ASTM D1434 82)

| | | | Transmission | Permeability |
|---|---|---|---|---|
| | | Foil | rate | cm³ · 1 |
| | Specimen | thickness | cm³/m²/d | μm/m²/d/bar |
| Material | No. | in μm | 23° C. dry | 23° C. dry |
| Ultrason P 3010 | 1/1 | 50.7 | 1.45E+02 | 7.45E+03 |
| 50 μm foil | 1/2 | 53.3 | 1.39E+02 | 7.51E+03 |
| Ultrason P 3010 | 2/1 | 89.3 | 6.37E+01 | 5.76E+03 |
| 100 μm foil | 2/2 | 87.4 | 6.42E+01 | 5.69E+03 |

TABLE 2
Ethane - Dry permeability (measured
in accordance with ASTM D1434 82)

| | | | Transmission | Permeability |
|---|---|---|---|---|
| | | Foil | rate | cm³ · 1 |
| | Specimen | thickness | cm³/m²/d | μm/m²/d/bar |
| Material | No. | in μm | 23° C. dry | 23° C. dry |
| Ultrason P 3010 | 1/1 | 50.7 | 2.53E+01 | 1.30E+03 |
| 50 μm foil | 1/2 | 53.3 | 2.22E+01 | 1.20E+03 |
| Ultrason P 3010 | 2/1 | 89.3 | 9.50E+00 | 8.60E+02 |
| 100 μm foil | 2/2 | 87.4 | 9.80E+00 | 8.68E+02 |

TABLE 3
Methane - Dry permeability (measured
in accordance with ASTM D1434 82)

| | | Transmission | Permeability |
|---|---|---|---|
| | | rate | cm³ · 1 |
| | Specimen | cm³/m²/d | μm/m²/d/bar |
| Material | No. | 23° C. dry | 23° C. dry |
| Ultrason P 3010 | 1/1 | 7.97E+01 | 7.05E+03 |
| 50 μm foil | 1/2 | 7.67E+01 | 6.77E+03 |
| HDPE (high density | 2/1 | 9.40E+02 | 4.79E+02 |
| polyethylene) | | | |
| 50 μm foil | 2/2 | 8.89E+02 | 5.00E+02 |
| PE100 (polyethylene) | | n.m. | ca. 3.5E+04 |
| 100 μm foil | | | |

1-14. (canceled)

15. A process to produce a self-supporting molding for conveying a gas which comprises utilizing the thermoplastic molding composition which comprises at least one polybiphenyl ether sulfone polymer.

16. The process according to claim 15, wherein the polybiphenyl ether sulfone polymer is produced through polycondensation comprising in step (a) the reaction of a component (a1) which comprises at least one aromatic dihydroxy compound with a component (a2) which comprises at least one aromatic sulfone compound having two halogen substituents, wherein component (a1) comprises 4,4′-dihydroxybiphenyl.

17. The process according to claim 16, wherein the polycondensation in step (a) is carried out in the presence of an organic solvent which comprises N-methylpyrrolidone.

18. The process according to claim 16, wherein the molar ratio (a1):(a2) of the components is from 1.005 to 1.1.

19. The process according to claim 16, wherein component (a1) comprises at least 50% by weight of 4,4′-dihydroxybiphenyl.

20. The process according to claim 16, wherein component (a2) is 4,4′-dihalo sulfone.

21. The process according to claim 16, wherein component (a2) is 4,4′-dichlorodiphenyl sulfone or 4,4′-difluorodiphenyl sulfone.

22. The process according to claim 16, wherein component (a1) is 4,4′-dihydroxybiphenyl and component (a2) is 4,4′-dichlorodiphenyl sulfone.

23. The process according to claim 15, wherein the molding composition further comprises at least one further polymer selected from the group consisting of polyether sulfone (PESU), polysulfone (PSU), polyetherimides, polyphenylene sulfides, polyether ether ketones, polyimides, and poly-p-phenylenes.

24. The process according to claim 23, wherein the content of the further polymer in the molding composition is at most 30% by weight, based on the total weight of the polymers comprised in the molding composition.

25. The process according to claim 15, wherein the self-supporting molding for conveying gas does not comprise a jacket.

26. The process according to claim 15, wherein the self-supporting molding for conveying gases have been selected from the group consisting of fittings and pipe sections.

27. A self-supporting molding which comprises utilizing a thermoplastic molding composition which comprises at least one polybiphenyl ether sulfone polymer.

28. A process for conveying a gas which comprises utilizing the self-supporting molding according to claim 27.

29. A process for the construction of piping systems for conveying a gas which comprises utilizing the molding according to claim 27.

30. The process according to claim 28, wherein the gas comprises methane and ethane.

31. The process according to claim 28, wherein the gas is natural gas.
